(19) United States
(12) Patent Application Publication
(10) Pub. No.: US 2005/0105912 A1
(43) Pub. Date: May 19, 2005

(54) Devices and methods for the remote management of on-premises fiber-optic transceivers

(76) Inventor: Eli Laufer, Woodland Hills, CA (US)

Correspondence Address: GARY L. SHAFFER, 901 BANKS PLACE, ALEXANDRIA, VA, 22312, US

(21) Appl. No.: 10/956,336

(22) Filed: Oct. 4, 2004

Related U.S. Application Data
(60) Provisional application No. 60/507,966, filed on Oct. 3, 2003.

(51) Int. Cl. H04B 10/00; G06F 15/173; G06F 15/16

(52) U.S. Cl. 398/140; 398/135; 709/223; 709/249

(57) ABSTRACT

Terminal devices and methods which enable reliable management access to network terminals located remotely on the premises of the network service receiver are provided. The invention is suitable for systems utilizing high-speed data packets transmitted via one or more high-speed data networks so that a network manager can access terminals via a management communication link to obtain information about the operating environment and conditions of the remote terminal. Using the management connections and circuitry provided by the invention, a manager can instruct a fiber-optic terminal thus enabled to perform operations that enable and support diagnostics and corrections to problems in the network. Network communication terminals can be managed via a special management port which typically connects to a management interface network, comprised of low-speed serial communication links, and operable with many communication protocols, such as IIC, SPI, and MI.

### RELATED APPLICATIONS

The present application claims priority to U.S. Provisional Application No. 60/507,966, filed Oct. 3, 2003. The cited Application is hereby incorporated by reference in its entirety.

### FIELD OF THE INVENTION

This invention deals with data communication, and specifically with data communication over optical fiber, and the management of interface devices associated with data communication over optical fibers.

### BACKGROUND OF THE INVENTION

The use of optical fibers in high-speed data communication, and the reach of optical fibers installations are constantly expanding. To guarantee a high degree of quality of service on communication networks, such network are constantly monitored, and managed. Monitoring and management require access to all of the components in the network, to observe proper operation conditions, for gathering of statistical information, and to control and alter modes of operations when necessary.

To facilitate management access to all the components comprising a conventional network, the components are typically equipped with special management access ports which are physically connected to the network manager terminal. When optical fibers are used as the means for communication in conventional networks, however, such direct connection of management terminals to the remote terminals is not possible.

In the past, the use of optical fibers was limited by the necessity for them to be located on the premises owned by the communication services provider. In conventional installations where optical fibers are limited in use to the network services provider facilities, physical connection to management ports is done using electrical wiring as an independent management network. In contrast, when optical fiber terminals are installed on the premises of the network service receiver, such direct physical connection to the terminal's management ports is not practical. Recently, however, because of their high-speed capabilities, terminal devices utilizing optical fibers are more frequently being installed remotely from network management facilities, that is, on the premises of the receivers of communication services.

### DESCRIPTION OF THE INVENTION

The present invention provides a series of devices and methods which enable the remote management of optical network terminals which are located on the premises of the network service receiver.

FIG. 1, shows a conventional optical fiber terminal in the form of a high-speed fiber-optic data transceiver. As shown, the typical transceiver has three ports. One of the three ports is an optical port, through which the transceiver interfaces with the optical fibers, and includes an optical transmitter and an optical receiver. Another of the three ports is a high-speed data port which is adapted for communication over high-speed conductive lines by way of a data network interface. The third port is typically a management port for management access to the management facilities in the transceiver. The management port typically connects to a management interface network, such as one comprising low-speed serial communication links, and operating in communication protocols such as IIC, SPI, and MI. Through the management port, the system manager can access the terminal via the management communication link, to obtain information about the ongoing operating environment and the condition of the terminal. The manager can also, using the management connections, instruct the terminal to perform operations that enable and support diagnostics of the potential problems in the network.

When such a conventional optical fiber terminal is installed on the premises of the network services receiver, because of its location remote from the management site, the management port cannot be connected to the management access network. The absence of such a management connection is shown in FIG. 2. Such a condition is very undesirable, typically because the remote diagnosis of potential problems is not possible, and therefore high quality communications service cannot be guaranteed. Thus, there is a need in the art for means and methods to monitor and manage remotely located fiber-optic terminals.

In one preferred embodiment of the present invention, management data and instructions are converted and encapsulated in the form of high-speed data packets, and then transmitted over the optical fibers as regular data packets. In one aspect, a solution provided by the invention requires that two circuits, preferably integrated circuits, be added to the terminal to be managed. A special management interface integrated circuit is used to interface to the remote terminal's management port, via a low-speed serial link, to send commands to the terminal, and to retrieve environmental and operational condition information from the terminal. The special integrated circuit is also adapted to interface with high-speed network protocols such as Ethernet, SONET, Fiber Channel, and the like, etc., over physical connections specified for these network protocols. The special integrated circuit receives instructions in the form of data packets, parses the received packets, interprets the instructions, and interfaces with the terminal via the management port, to execute the instruction sent by the network manager. The special integrated circuit also controls the retrieval of management information from the terminal, temporarily stores that information, encapsulates the retrieved data into a regular data packet conforming to the desired network protocol, and sends out the data packet in the desired network format.

A second element required by the invention is a network bridge, or switch, having a minimum of three high-speed data network ports. One port connects to the high-speed data port of the terminal, a second port connects to the high-speed data port of the special management interface integrated circuit, and at least one other port is utilized by the high speed data network service receiver as an interface port.

A network bridge device configured for use as part of the invention may also have a low-speed serial management interface port. The low-speed serial management interface port is enabled and arranged to be connected to the special management interface integrated circuit in order to allow remote management access to the bridge device. Management access to the bridge device allows the remote control of its modes of operation, the gathering of data flow related statistics, and the performance and management of link diagnostics.

Combined as described herein, a remote terminal of the invention comprises an optical fiber transceiver, a special management interface integrated circuit, and a high-speed data network bridge, to thereby provide the means and methods such that management access for remote terminals can be located anywhere, and can be enabled to perform all normal management operations while still utilizing high-speed data packets transmitted over high-speed data network fibers and cable. Thus, it is an object of the invention to provide means and methods to monitor and manage remotely located fiber-optic terminals. It is a similar object of the invention to provide methods to monitor and manage remotely located fiber-optic terminals.

### BRIEF DESCRIPTIONS OF THE DRAWINGS

FIG. 1, Shows a prior art optical fiber terminal on network service provider premises.

FIG. 2, Shows a prior art optical fiber terminal on network service receiver premises.

FIG. 3, shows one preferred embodiment of an optical fiber terminal of the invention located on an exemplary network service receiver premises, with remote management capabilities.

FIG. 4, shows an embodiment of a special management interface integrated circuit of the invention.

FIG. 5, shows an embodiment of a managed optical transceiver according to the invention.

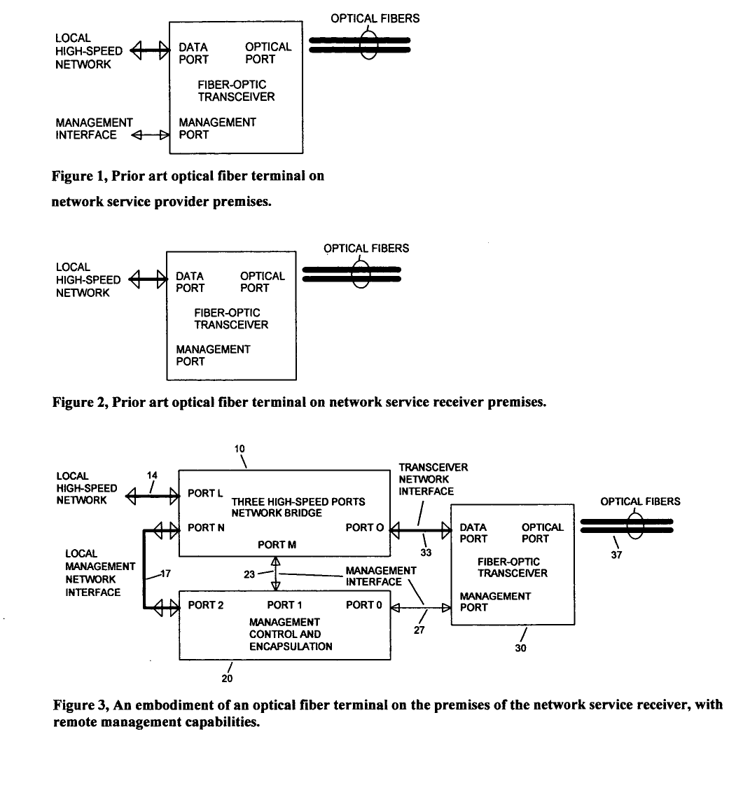

### SUMMARY AND OBJECTS OF THE INVENTION

In accordance with the above-stated and other objects, an optical fiber terminal adaptable to being remotely managed in a data network is provided, the terminal comprising an optical transceiver, a data network bridge, and a management interface controller. Preferably, the optical transceiver, comprises at least one optical port, at least one data port, and at least one management port; a data network bridge, the network bridge comprising a plurality of ports adapted for receiving and sending data over a network; and a management interface controller, wherein the controller comprises communicative connections to the transceiver and to the bridge such that the functional parameters of the terminal can be monitored and managed from a remote location in the network.

Preferably, the plurality of ports of the data network bridge comprises a minimum of three high-speed data network ports, each of the ports being adapted for transferring high-speed data between and among the high-speed ports, and the management interface controller comprises at least one low-speed serial management interface port, and at least one high-speed data network port, wherein the high-speed port is adaptable for communication with one or more networks.

A management interface controller of the invention is adapted and arranged such that low-speed management data received via the low-speed serial management interface port is encapsulated in a standard data network packet and transmitted as a high-speed packet via the high-speed data port. Preferably, the management interface controller comprises at least one integrated circuit, wherein the circuit is adapted and arranged to a) to receive low-speed management data, b) to encapsulate the received low-speed management data into a standard data network packet, and c) to transmit the encapsulated network packet as a high-speed packet via the high-speed data port. Moreover, the management interface controller is adapted and arranged to receive and process management instructions from management controllers regarding the terminal or components or portions of the controller such that high-speed packets received via the high-speed data network compatible port are parsed and decoded to determine from the instructions the requested actions to be taken with respect to management of the optical terminal or the portions thereof, and to effect communications within the controller to carry out the requested actions.

Preferably, the terminal interface controller communicates with management controllers and interfaces of components of the optical terminal via low-speed management communication ports in order to carry out the one or more requests for action received via the high-speed data network port. A terminal of the invention is adapted and arranged such that a network manager can access the management controllers in the terminal by virtue of high-speed data packets, and management commands can be delivered to the terminal as high-speed data packets via a high-speed data network.

A variety of monitoring and managing functions can be carried out with respect to a remotely located terminal. For instance, the requested actions can be one or more from the group comprising monitoring control currents in the optical transmitter to determine their values or ranges, setting diagnostic provisions in the remote terminal to an instructed value or range, re-setting diagnostic provisions in the terminal to an instructed value or range, transmitting the values or ranges; monitoring and obtaining the operating temperature of the laser diode in the transmitter, and transmitting the value or range of values of the operating temperature of the laser diode via a high-speed data network to the management controller.

As additional advantages, the actions or commands sent from one or more management controllers can be one or more from the group comprising: monitoring the magnitude of signals received in the optical receiver, obtaining the magnitude of the signals and transmitting the magnitude value or range of values of the signals via a high-speed data network to the management controller, monitoring the magnitudes of operating bias and modulation currents driving the laser diode in the transmitter, obtaining the magnitude of the operating bias and modulation currents and transmitting the values of the operating bias and modulation currents via a high-speed data network to the management controller.

Yet other functions of the remote terminal can be remotely managed, including wherein the commands or requested actions are one or more from the group comprising:
receiving an action command from a network management terminal to set the bias and modulation currents driving the laser diode in the transmitter to a desired value or range, setting the bias and modulation currents as instructed by the command, and reporting the completion of the action to the management controller.

In one set of preferred embodiments, the controller is communicatively connected with the management port of the transceiver by way of a first of the three high-speed ports, the controller is communicatively connected with the high-speed ports of the bridge by way of a second of the three high-speed ports, and the optical transceiver and the network bridge are communicatively interconnected by an interface such that the remote terminal is enabled for receiving and responding to management inquiries and commands. Terminals of the invention can be interconnected in numerous ways to form one or more communication networks. Thus, one or a plurality of terminals of the invention can be communicatively connected to at least one network, or can be communicatively interconnected between a first network and a second network wherein one or both of the networks are high-speed networks or one is a high-speed network and the second network is a low-speed network. A plurality of terminals of the invention can be communicatively interconnected to one another, for example, such that a first subset of the plurality forms a first network, a second subset of the plurality forms a second network, and the first and the second networks are interconnected with one another.

The invention also includes methods for managing a remotely located fiber-optic transceiver. One preferred method comprises the steps of: i) providing an optical fiber terminal adaptable to being remotely managed in a data network, the terminal comprising an optical transceiver, the transceiver comprising at least one optical port, at least one data port, and at least one management port; a data network bridge, the bridge comprising a plurality of ports adapted for receiving and sending data over a network; and a management interface controller, wherein the controller comprises communicative connections to the transceiver and to the bridge such that the functional parameters of the terminal can be monitored and managed from a remote location in the network, and ii) operating the management interface controller to receive and process management instructions from management controllers regarding the terminal or portions thereof, such that high-speed packets received via the high-speed data network compatible port are parsed and decoded to a) determine from the instructions the requested actions to be taken with respect to management of the optical terminal or the portions thereof, and b) effect communications within the controller to carry out the requested actions, and iii) operating the management interface controller to communicate with management controllers and interfaces of components of the optical terminal via low-speed management communication ports in order to carry out the requests for action received via the high-speed data network port.

In accordance with additional objects of the methods of the invention, the terminal is preferably adapted and arranged such that a network manager can access the management controllers in the terminal by virtue of high-speed data packets, and management commands can be delivered to the terminal as high-speed data packets via a high-speed data network. Moreover, methods of the invention include wherein the terminal is communicatively connected to at least one network, or communicatively interconnected between a first network and a second network, or between or among a plurality of high-speed or low-speed networks.

### DETAILED DESCRIPTION OF THE INVENTION

In the following detailed description, reference is made to the accompanying drawings, which form a part hereof, and in which are shown by way of illustration of specific embodiments in which the invention may be practiced. The embodiments shown in the drawings include only a few examples of the many embodiments disclosed herein, and are provided in sufficient detail to enable those of ordinary skill in the art, to make and use the invention. It is to be understood that many structural, logical or procedural changes may be made to the specific embodiments disclosed without departing from the spirit and scope of the present invention.

FIG. 3, presents a typical embodiment of the invention wherein an optical fiber terminal is located on the premises of the network service receiver, and is adapted to be managed from a location remote from of the service receiver. In one aspect, the transceiver comprises three major components, an optical transceiver 30, a special management control and encapsulation integrated circuit 20, and a high-speed network bridge 10, the bridge preferably having a minimum of three high-speed data network ports.

The optical fiber transceiver 30, shown in FIG. 5, is used to receive optical signals, and transmit optical signals via the optical fiber(s) 37. The optical transceiver 30 comprises of an optical transmitter 100, an optical receiver 110, and a management interface controller 120. It connects to the optical fibers 37 on its optical port, and it also converts optical signals received via the optical port into high-speed electrical signals, made available on the high-speed data network 33 port. The management interface controller 120, sets the desired bias and modulation currents in the transmitter 100, it monitors the actual bias and modulation currents, and the temperature of the laser diode. The management controller 120 also monitors the level of the signal received in the receiver, and can setup a loop-back path for diagnostics of the optical fiber. The management interface controller 120 connects to the low-speed management interface link.

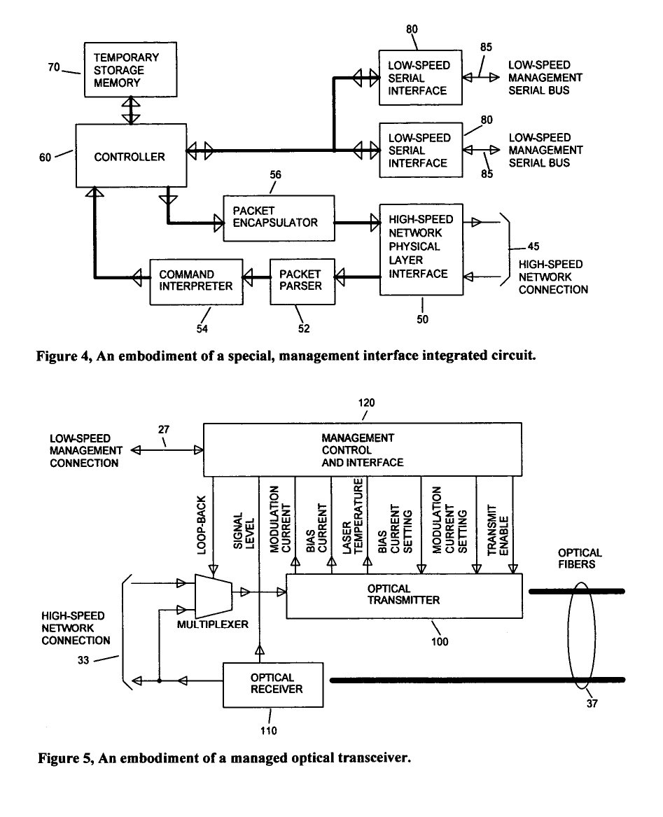

An embodiment of the special management control and encapsulation integrated circuit 20, is shown in FIG. 4. The special device 20 interfaces with a high-speed data network 45 via its high-speed data network port. On its high-speed data network physical layer interface (PHY) 50, it receives special packets from the high-speed data network 45. Received packets are transferred to the packet parser 52, which “opens up” the packets and determines the contents of the packets. The parser finds the part in a packet that contains the operational instructions, and transfers them the command interpreter 54, which determines what operational instruction was received, and transfers the instructions to the controller 60 for execution.

The controller 60, upon receiving an instruction from the command interpreter 54, starts a chain of operations to execute the received instruction. Such instructions may include, but not limited to, setting of the transmitter's currents, monitoring the transmitter's currents, monitoring the temperature of the laser diode in the transmitter, and monitoring the magnitude of signals received in the receiver. To execute the instructions, the controller 60 communicate with the management control 120 in the transceiver 30, via the low-speed management interface link 27, to setup desired levels, or to retrieve the requested information from the transceiver unit 30.

The management controller 120 in the transceiver 30 responds to communication with the controller 60 in the terminal by setting of levels, or transmission of requested information. A full handshake protocol is provided in the low-speed management link to facilitate bi-directional transfer of data and instructions.

In response to information received from the management controller 120 in the transceiver 30, the controller 60 transfers the received information to the packet encapsulator 57. The encapsularor encapsulates the data in a standard packet format, and then sends the encapsulated packet to the PHY 50 for transmittal over the high-speed data network 45.

The high-speed data network bridge 10 enables three ways of communication in the terminal. It enables high-speed data to be transferred via the high-speed data link 33 between the transceiver 30 and the high-speed data network services receiver 14. It also enables data transfer between the transceiver 30 and the special management control and encapsulation integrated circuit 20 via the high-speed data link 17, and transfer of data between the network services receiver 14, and the special management control and encapsulation integrated circuit 20. This three-way communication allows the high-speed data network services receiver normal access to the network via the optical fibers. It allows the network manager access to terminals on the premises of the high-speed data network services receiver, and even provides the high-speed data network services receiver management access to the optical terminal, without a need for a separate management communication link.

While the invention has been described in detail in connection with preferred embodiments known at the time, it should be readily understood that the invention is not limited to the disclosed embodiments. Rather, the present devices, apparatus and methods can be modified to incorporate any number of variations, alterations, substitutions or equivalent arrangements not heretofore specifically described, but which are commensurate with the spirit and scope of the invention.

1. An optical fiber terminal adaptable to being remotely managed in a data network, said terminal comprising:
A) an optical transceiver,
said transceiver comprising at least one optical port, at least one data port, and at least one management port;
B) a data network bridge,
said bridge comprising a plurality of ports adapted for receiving and sending data over a network; and
C) a management interface controller,
wherein said controller comprises communicative connections to said transceiver and to said bridge such that the functional parameters of said terminal can be monitored and managed from a remote location in said network.

2. The terminal of claim 1, wherein said plurality of ports of said data network bridge comprises a minimum of three high-speed data network ports, each of said ports being adapted for transferring high-speed data between and among said high-speed ports.

3. The terminal of claim 1, wherein said management interface controller comprises a) at least one low-speed serial management interface port, and
b) at least one high-speed data network port, wherein said high-speed port is adaptable for communication with a network.

4. The terminal of claim 1, wherein said management interface controller is adapted and arranged such that low-speed management data received via said low-speed serial management interface port is encapsulated in a standard data network packet and transmitted as a high-speed packet via said high-speed data port.

5. The terminal of claim 1, wherein said management interface controller comprises at least one integrated circuit, wherein said at least one circuit is adapted and arranged to a) to receive low-speed management data, b) to encapsulate said received low-speed management data into a standard data network packet, and c) to transmit said encapsulated network packet as a high-speed packet via said high-speed data port.

6. The terminal of claim 3, wherein said management interface controller is adapted and arranged to receive and process management instructions from management controllers regarding said terminal or portions thereof,
such that high-speed packets received via said high-speed data network compatible port are parsed and decoded to
a) determine from said instructions the requested actions to be taken with respect to management of said optical terminal or said portions thereof, and
b) effect communications within said controller to carry out said requested actions.

7. The terminal of claim 6, wherein said controller communicates with management controllers and interfaces of components of the optical terminal via low-speed management communication ports in order to carry out said request for action received via the high-speed data network port.

8. The terminal of claim 6, wherein said terminal is adapted and arranged such that a network manager can access the management controllers in the terminal by virtue of high-speed data packets, and management commands can be delivered to said terminal as high-speed data packets via a high-speed data network.

9. The terminal of claim 6, wherein said requested actions are one or more from the group comprising: monitoring control currents in said optical transmitter to determine their values or ranges, setting diagnostic provisions in said terminal to an instructed value or range, re-setting diagnostic provisions in the terminal to an instructed value or range, and transmitting said values or ranges; monitoring the operating temperature of the laser diode in the transmitter, obtaining said operating temperature of said laser diode, and transmitting the value or range of said operating temperature of said laser diode via a high-speed data network to said management controller.

10. The terminal of claim 6, wherein said requested actions are one or more from the group comprising: monitoring the magnitude of signals received in said optical receiver, obtaining the magnitude of said signals and transmitting the magnitude value or range of values of said signals via a high-speed data network to said management controller, monitoring the magnitudes of operating bias and modulation currents driving the laser diode in said transmitter, obtaining the magnitude of said operating bias and modulation currents and transmitting the values of said operating bias and modulation currents via a high-speed data network to said management controller.

11. The terminal of claim 6, wherein said requested actions are one or more from the group comprising: receiving an action command from a network management terminal to set the bias and modulation currents driving the laser diode in the transmitter to a desired value or range, setting said bias and modulation currents as instructed by the command, and reporting the completion of said action to said management controller.

12. The terminal of claim 1, wherein said controller is communicatively connected with said management port of said transceiver by way of a first of said three high-speed ports, wherein said controller is communicatively connected with said high-speed ports of said bridge by way of a second of said three high-speed ports, and wherein said optical transceiver and said network bridge are communicatively interconnected by an interface such that

13. The terminal of claim 1, wherein said terminal is communicatively connected to at least one network.

14. The terminal of claim 1, wherein said terminal is communicatively interconnected between a first network and a second network.

15. The terminal of claim 14, wherein said first network is a high-speed network and said second network is a low-speed network.

16. The terminal of claim 1, wherein said first and said second networks are both high-speed networks.

17. A plurality of terminals according to claim 1, wherein each of said terminals are communicatively interconnected in a network.

18. A plurality of terminals according to claim 1, wherein a first subset of said plurality forms a first network, a second subset of said plurality forms a second network, and wherein said first and said second networks are communicatively interconnected to one another.

19. A method for managing a remotely located fiber-optic transceiver comprising the steps of:
i) providing an optical fiber terminal adaptable to being remotely managed in a data network, said terminal comprising:
A) an optical transceiver,
said transceiver comprising at least one optical port, at least one data port, and at least one management port;
B) a data network bridge,
said bridge comprising a plurality of ports adapted for receiving and sending data over a network; and
C) a management interface controller,
wherein said controller comprises communicative connections to said transceiver and to said bridge such that the functional parameters of said terminal can be monitored and managed from a remote location in said network, and
ii) operating said management interface controller to receive and process management instructions from management controllers regarding said terminal or portions thereof, such that high-speed packets received via said high-speed data network compatible port are parsed and decoded to
a) determine from said instructions the requested actions to be taken with respect to management of said optical terminal or said portions thereof, and
b) effect communications within said controller to carry out said requested actions, and
iii) operating said management interface controller to communicate with management controllers and interfaces of components of said optical terminal via low-speed management communication ports in order to carry out said requests for action received via the high-speed data network port.

20. The method of claim 19, wherein said terminal is adapted and arranged such that a network manager can access the management controllers in the terminal by virtue of high-speed data packets, and management commands can be delivered to said terminal as high-speed data packets via a high-speed data network.

21. The method of claim 19, wherein said requested actions are one or more from the group comprising: monitoring control currents in said optical transmitter to determine their values or ranges, setting diagnostic provisions in said terminal to an instructed value or range, re-setting diagnostic provisions in the terminal to an instructed value or range, and transmitting said values or ranges; monitoring the operating temperature of the laser diode in the transmitter, obtaining said operating temperature of said laser diode, and transmitting the value or range of said operating temperature of said laser diode via a high-speed data network to said management controller.

22. The method of claim 19, wherein said requested actions are one or more from the group comprising: monitoring the magnitude of signals received in said optical receiver, obtaining the magnitude of said signals and transmitting the magnitude value or range of values of said signals via a high-speed data network to said management controller, monitoring the magnitudes of operating bias and modulation currents driving the laser diode in said transmitter, obtaining the magnitude of said operating bias and modulation currents and transmitting the values of said operating bias and modulation currents via a high-speed data network to said management controller.

23. The method of claim 19, wherein said requested actions are one or more from the group comprising: receiving an action command from a network management terminal to set the bias and modulation currents driving the laser diode in the transmitter to a desired value or range, setting said bias and modulation currents as instructed by the command, and reporting the completion of said action to said management controller.

24. The method of claim 19, wherein said controller is communicatively connected with said management port of said transceiver by way of a first of said three high-speed ports, wherein said controller is communicatively connected with said high-speed ports of said bridge by way of a second of said three high-speed ports, and wherein said optical transceiver and said network bridge are communicatively interconnected by an interface such that

25. The method of claim 19, wherein said terminal is communicatively connected to at least one network.

26. The method of claim 19, wherein said terminal is communicatively interconnected between a first network and a second network.

27. The method of claim 19, wherein said first network is a high-speed network and said second network is a low-speed network.
